(19) United States
(12) Patent Application Publication
(10) Pub. No.: US 2025/0384567 A1
(43) Pub. Date: Dec. 18, 2025

(54) CONTROL METHOD OF OBJECT INFORMATION INTEGRATED MONITORING SYSTEM

(71) Applicant: HANWHA VISION CO., LTD., Seongnam-si (KR)

(72) Inventors: Young Hun LEE, Seongnam-Si (KR); Do Hyun KIM, Seongnam-Si (KR); Dae Hyun RYU, Seongnam-Si (KR)

(73) Assignee: HANWHA VISION CO., LTD., Seongnam-si (KR)

(21) Appl. No.: 19/302,766

(22) Filed: Aug. 18, 2025

Related U.S. Application Data
(63) Continuation of application No. PCT/KR2024/003620, filed on Mar. 22, 2024.

(30) Foreign Application Priority Data
Apr. 13, 2023 (KR) 10-2023-0048530

(51) Int. Cl. G06T 7/292; G06V 20/52; G06V 40/10; G06V 40/20; G08B 13/196; G08B 21/22

(52) U.S. Cl. CPC G06T 7/292; G06V 20/52; G06V 40/10; G06V 40/20; G08B 13/19608; G08B 13/19645; G08B 21/22; G06T 2207/30196; G06T 2207/30232

(57) ABSTRACT

There is provided a control method of an object information integrated monitoring system. The control method includes: recognizing at least one first object in a first image captured by a first camera, setting a bounding box with respect to the at least one first object, and tracking the at least one first object; obtaining analytical information by analyzing the first image including the at least one first object; and displaying, based on the analytical information, an image map corresponding to the captured first image, wherein the displaying comprises displaying, on the image map, analytical information of the at least one first object while tracking a movement path of the at least one first object on the image map.

### CROSS-REFERENCE TO RELATED APPLICATION(S)

This application is a continuation application of International Application No. PCT/KR2024/003620 filed on Mar. 22, 2024, in the Korean Intellectual Property Receiving Office, which is based on and claims priority to Korean Patent Application No. 10-2023-0048530, filed on Apr. 13, 2023, in the Korean Intellectual Property Office, the disclosures of which are incorporated by reference herein in their entireties.

### BACKGROUND

### 1. Field

The present disclosure relates to a control method for an object information integrated monitoring system, and more particularly, to a control method for an object information integrated monitoring system capable of capturing one or more objects and integrally checking information on the one or more objects on an image map.

### 2. Description of Related Art

Recently, the demand for intelligent Closed Circuit Television (CCTV) systems that analyze video images input from a CCTV in real time to detect and track moving objects and automatically detect meaningful events based thereon has been steadily increasing.

Furthermore, the use of intelligent CCTV systems is gradually expanding not only in the field of security/surveillance but also in the field of Business Intelligence (BI). A representative example includes counting the number of visitors who pass by, by analyzing videos from cameras installed at store entrances or passageways, or measuring a period of time during which visitors stay in a specific location.

However, while an object tracking apparatus in the related art may provide the function of tracking multiple objects recognized by multiple cameras, the apparatus merely tracks the movement path of each object and display the movement path on an image map. Thus, information on each object or information that organically arises between multiple objects still has to be checked and individually analyzed by a supervisor, which is cumbersome.

### SUMMARY

The present disclosure addresses the above problems, and more specifically, provides a control method for an object information integrated monitoring system that may use cameras to recognize one or more objects, store information on the one or more objects on a server, and display analytical information inferable from each object on an image map.

According to an aspect of an example embodiment, provided is a control method of an object information integrated monitoring system, including: recognizing at least one first object in a first image captured by a first camera, setting a bounding box with respect to the at least one first object, and tracking the at least one first object; obtaining analytical information by analyzing the first image including the at least one first object; and displaying, based on the analytical information, an image map corresponding to the captured first image, wherein the displaying comprises displaying, on the image map, analytical information of the at least one first object while tracking a movement path of the at least one first object on the image map.

The control method may further include recognizing at least one second object appearing in a second image captured by a second camera, setting a bounding box with respect to the at least one second object, and tracking the at least one second object.

The displaying may include: recognizing that an object, among the at least one first object, recognized in the first image and an object, is a same object as an object, among the at least one second object, recognized in the second image, tracking a movement path of the same object on the image map, and displaying analytical information of the same object.

The at least one first object may include a person and the analytical information of the at least one first object may include at least one or more pieces of information among height, age, gender, clothing, presence or absence of disability, location coordinates, movement path, movement speed, possession of a weapon, density by unit area, exposure time in the first image, and clustering trend.

The analyzing the first image may include setting a restricted area, which is in a designated area of the first image, on the image map.

The restricted area may include: an area that requires an access authentication procedure, an authorized-person-only area to which only a specific object is allowed to enter without authentication, an area to which access is restricted based on gender, and a no-entry zone to which access is not allowed.

The restricted area may include at least one of a security area, a mechanical room, a server room, a security room, a restroom, or a nursing room.

The displaying the image map may include displaying the image map including a warning notification, based on a determination that an object among the at least one first object who is not allowed to enter the restricted area has entered the restricted area.

The determination that an object among the at least one first object who is not allowed to enter the restricted area has entered the restricted area may include a determination that an object among the at least one first object enters the restricted area without undergoing access authentication, is an object of a gender different from an allowed gender of the restricted area, or enters the no-entry zone.

The displaying the image map may include displaying the image map including an event notification based on at least one of conditions being met, the conditions comprising: a first condition that a specific object is repeatedly and/or periodically exposed based on the stored analytical information, a second condition that a specific object is exposed on the image map and/or stays in the restricted area for a preset time or longer, a third condition that a density of objects in a unit area exceeds a set range, a fourth condition that one or more objects move at a speed exceeding a preset speed range, a fifth condition that a specific object deviates from a cluster formed by multiple objects, and a sixth condition that at least one object possesses a weapon.

The displaying the image may map may include displaying the image map and an image from a camera capturing a specific object corresponding to the warning notification or the event notification.

The at least one first object may include a vehicle and the analytical information of the at least one first object may include at least one or more pieces of information among a vehicle number, color, type, size, location coordinates, movement path, movement speed, entry or exit time, whether a predefined person object is boarding, and a number of person objects boarding or alighting.

The obtaining the analytical information may include setting an exception object among the at least one first object.

The setting the exception object may include: setting, as an exception object, an object for which a warning notification is required or which satisfies the at least one of conditions, and displaying a movement path or analytical information of the exception object on the image map.

According to an aspect of an example embodiment, provided is an object information integrated monitoring system including: a memory storing instructions; and at least one processor configured to execute the instructions, wherein, by executing the instructions, the at least one processor is configured to perform: recognizing at least one first object in a first image captured by a first camera, setting a bounding box with respect to the at least one first object, and tracking the at least one first object; obtaining analytical information by analyzing the first image including the at least one first object; and displaying, based on the analytical information, an image map corresponding to the captured first image, wherein the displaying includes displaying, on the image map, analytical information of the at least one first object while tracking a movement path of the at least one first object on the image map.

The at least one processor may be further configured to perform: recognizing at least one second object appearing in a second image captured by a second camera; setting a bounding box with respect to the at least one second object; and tracking the at least one second object.

The at least one processor may be further configured to perform, in displaying the image map: recognizing that an object, among the at least one first object, recognized in the first image and an object, is a same object as an object, among the at least one second object, recognized in the second image; tracking a movement path of the same object on the image map; and displaying analytical information of the same object.

### BRIEF DESCRIPTION OF DRAWINGS

The above and other aspects, features, and advantages of example embodiments of the present disclosure will be more clearly understood from the following detailed description, taken in conjunction with the accompanying drawings. The drawings illustrate example embodiments of the present disclosure for illustrative purposes. However, it should be understood that the application is not limited to the exact arrangements and means shown.

FIG. 1 is a block diagram illustrating a control method for an object information integrated monitoring system according to an embodiment of the present disclosure.

FIG. 2 is a view illustrating an example of an image map of the object information integrated monitoring system illustrated in FIG. 1.

FIG. 3 is a view illustrating an example in which an alert notification is displayed on an image map of the object information integrated monitoring system illustrated in FIG. 1.

FIG. 4 is a view illustrating an example in which a camera image related to the alert notification is displayed on the image map illustrated in FIG. 3.

FIGS. 5 and 6 are views illustrating examples in which an event notification is displayed on the image map of the object information integrated monitoring system illustrated in FIG. 3.

FIG. 7 is a view illustrating an example in which a movement path of an object is displayed on the image map illustrated in FIG. 5.

FIG. 8 is a block diagram illustrating a configuration of the object information integrated monitoring system according to an embodiment of the present disclosure.

FIG. 9 is a diagram illustrating an example of a hardware configuration of a computing device for implementing the object information integrated monitoring system illustrated in FIG. 8.

### DETAILED DESCRIPTION

The present disclosure is susceptible to various modifications and includes various embodiments. Specific example embodiments will be illustrated and described in the drawings.

However, this is not intended to limit the present disclosure to such specific embodiments, and it should be understood to include all modifications, equivalents, and alternatives within the spirit and scope of the disclosure.

Terms including ordinal numbers such as first, second, etc., may be used to describe various components, but these components are not limited by these terms.

These terms are used only to distinguish one component from another.

For example, a second component can be named a first component without departing from the scope of the disclosure, and similarly, a first component can be named a second component.

The term “and/or” includes any combination of one or more of the associated listed items or any of the listed items individually.

When a component is said to be “connected to” or “coupled to” another component, it may be directly connected or coupled to the other component, or intervening components may be present.

Conversely, when a component is said to be “directly connected to” or “directly coupled to” another component, there are no intervening components.

The terms used in this application are for the purpose of describing particular embodiments only and are not intended to limit the disclosure.

Unless the context clearly indicates otherwise, singular forms include plural forms as well.

In this application, terms such as “comprising” or “having” are intended to specify the presence of stated features, numbers, steps, operations, elements, components, or combinations thereof, but do not preclude the presence or addition of one or more other features, numbers, steps, operations, elements, components, or combinations thereof.

Embodiments will hereinafter be described with reference to the accompanying drawings, wherein the same or corresponding components, regardless of the drawing numbers, are assigned the same reference numbers, and redundant descriptions will be omitted.

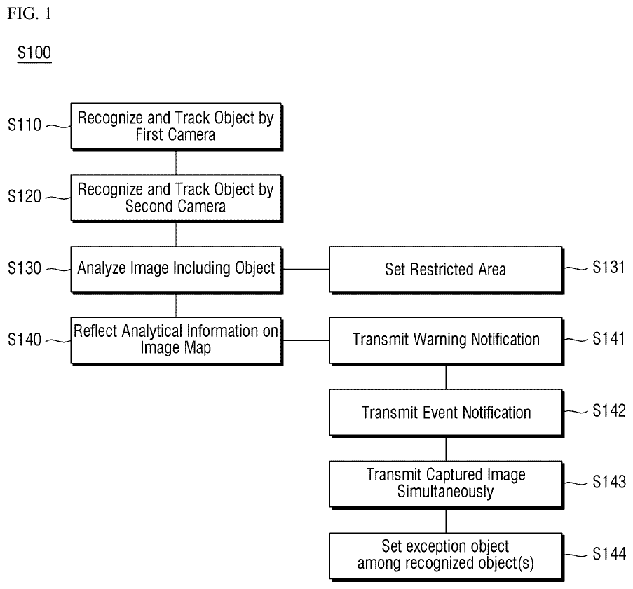

FIG. 1 is a block diagram illustrating an object information integrated monitoring system according to an embodiment of the present disclosure.

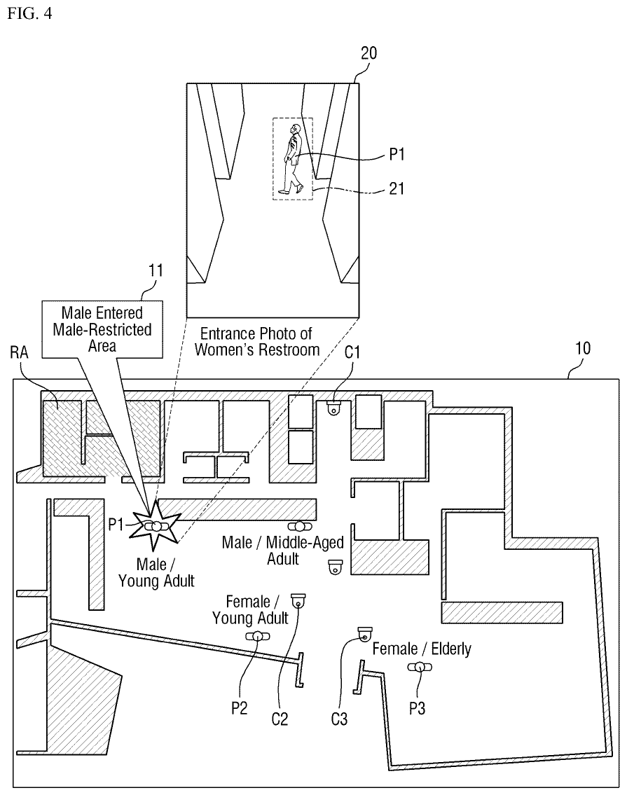

Referring to FIG. 1, a control method S100 for an object information integrated monitoring system according to an embodiment of the present disclosure may include includes recognizing, by a first camera, an object, setting a bounding box (e.g., 21 in FIG. 4), and tracking the recognized object (S110); recognizing, by a second camera, an object, setting a bounding box, and tracking the recognized object (S120); analyzing images including the recognized object(s) (S130); reflecting analytical information on a two-dimensional image map corresponding to the captured images (S140).

In step S110, which is the step of recognizing, by the first camera, an object, setting a bounding box, and tracking the object, and step S120, which is the step of recognizing, by the second camera, an object, setting a bounding box, and tracking the object, one or more objects are recognized from images captured by the first and second cameras. The first camera may set a bounding box for an object recognized in a first image, and the second camera may set a bounding box for an object recognized in a second image.

Here, the first camera and the second camera to be described in more detail later may be implemented as artificial intelligence (AI)-based automatic tracking cameras. Although not illustrated in the drawings, such cameras may have a panning function in a horizontal direction, a tilting function in a vertical direction, and/or a zoom function, or may be applied to fixed cameras that provide a fixed angle of view. In addition, such cameras may automatically track one or more objects. Also, a location of each camera may be displayed on an image map.

A bounding box may be set around an object recognized in the image captured by each camera. For example, the bounding box may have a substantially rectangular shape and be formed to have a size or area proportional to a size of the object recognized in the image. Accordingly, when a bounding box appears in an image captured by a camera, it may mean that the camera has recognized the object in an area corresponding to the bounding box.

The first and second cameras may be installed at different, spaced-apart locations. Therefore, a first space captured by the first camera and a second space captured by the second camera may be different spaces, and one of the first and second spaces may partially or entirely overlap with the other one of the first and second spaces. Alternatively, the first and second spaces may be completely separate spaces with no overlapping regions. In this embodiment, a case in which the first and second spaces partially overlap is described as an example. That is, the first image captured by the first camera may include a capture region that partially overlaps with the second image captured by the second camera. For example, when a specific object that appears in the first image moves in a certain direction, the specific object may temporarily appear in the first image, then disappear from the first image and be captured only in the second image.

Step S130, which is the step of analyzing images including the recognized object, may involve applying cameras equipped with an AI algorithm to provide analytical information on the object and analytical information in the images including the object in real time. Alternatively, a separate control unit that receives the images from the first and second cameras may analyze the images and provide the analytical information.

Step S140, which is the step of reflecting the analytical information on a two-dimensional image map corresponding to the captured images, may display the image map on a user terminal (e.g., a mobile phone, tablet PC, etc.) or a personal or office PC that a supervisor may check, and may display in real time analytical information such as positions of the recognized object shown in the first and second images, and analytical information of the surroundings of the objects in the camera-captured images. The image map may be represented as a two-dimensional plan view and may be expressed as an arbitrary simplified map structure that reflects the space or structure corresponding to each image. The position of an object on the image map may be expressed as coordinates, and a position of a specific object on a two-dimensional plane may be represented as p1(x, y).

In addition, step S140, which is the step of reflecting the analytical information on the image map, may automatically track a movement path of the recognized object and display the analytical information related to the recognized object on the image map. Such an image map may correspond to a specially processed map for a predetermined purpose.

Here, when the recognized object is a person, the analytical information on the object may include, for example but not limited to, at least one, or more than one, piece of information from among height, age, gender, clothing, disability status, whether armed, location coordinates, movement path, movement speed, density by unit area, exposure time in the first or second image, and clustering trend, etc.

In addition, when the recognized object is a vehicle, the analytical information on the object may include, for example but not limited to, at least one, or more than one, piece of information from among vehicle number, color, type, size, location coordinates, movement path, movement speed, entry or exit time, whether a preset person object is boarding, and the number of boarding or alighting person objects.

Such analytical information may be stored on a separately prepared server. A detailed description of example embodiments regarding the analytical information displayed on the image map will be provided later.

Step S130, which is the step of analyzing the images including the object, may include setting a restricted area (S131). Step S131, which is the step of setting a restricted area, may set a restricted area on the image map in the space captured in the first or second image. For example, the restricted area may include, for example but not limited to: a server room, a security area, and a machine room that require access authentication procedures; an area designated for specific authorized persons without authentication procedures; a gender-restricted area such as a restroom or a nursing room; and a no-entry zone due to construction or cleaning.

Step S140, which is the step of reflecting the analytical information on the image map, may include transmitting an alert notification (S141). Step S141, which is the step of transmitting an alert notification, may transmit an alert notification to the supervisor in situations such as, for example but not limited to: an object enters a restricted area without going through access authentication, an object of a gender different from the permitted gender enters a restricted area, or an object enters a no-entry zone.

Step S140, which is the step of reflecting the analytical information on the image map, may include transmitting an event notification (S142). Step S142, which is the step of transmitting an event notification, may transmit an event notification to the supervisor if at least one condition is satisfied based on the stored analytical information. Conditions for event notification may include, for example but not limited to: a first condition in which a specific object is repeatedly and/or periodically exposed (or detected) on the image map; a second condition in which a specific object is exposed on the image map, or stays in a restricted area, for a longer period than a preset time; a third condition in which the density of objects in a unit area on the image map exceeds a preset range; a fourth condition in which one or more objects move at a speed exceeding a preset movement speed range; a fifth condition in which a specific object deviates from a cluster formed by multiple objects; and a sixth condition in which at least one person object possesses a weapon such as a knife or firearm.

In this case, step S140, which is the step of reflecting the analytical information on the image map, may include simultaneously transmitting images currently being captured by the cameras (e.g., the first and second cameras) in the process of transmitting an alert notification or displaying an event notification on the image map (S143). For example, in response to an alert notification or event notification being transmitted, the supervisor may receive only the notification and check the situation via the image map. By further including step S143, which is the step of simultaneously transmitting the images currently being captured, real-time camera images corresponding to the alert or event notification may be simultaneously transmitted on the image map, thereby allowing the supervisor to more accurately determine the situation and location.

In addition, step S140, which is the step of reflecting the analytical information on the image map, may include setting an exception object among the recognized object (S144).

Step S144, which is the step of setting an exception object, may designate one or more specific objects satisfying the at least one condition in step S141, which is the step of transmitting an alert notification, and step S142, which is the step of transmitting an event notification, as an exception object. Step S144, which is the step of setting an exception object, may display a movement path or analytical information of the exception object on the image map. Accordingly, since the movement path and analytical information of the exception object are separately marked on the image map, it becomes easier to distinguish the exception object from a general (or non-exception) recognized object, and time required to track only the exception object may be saved.

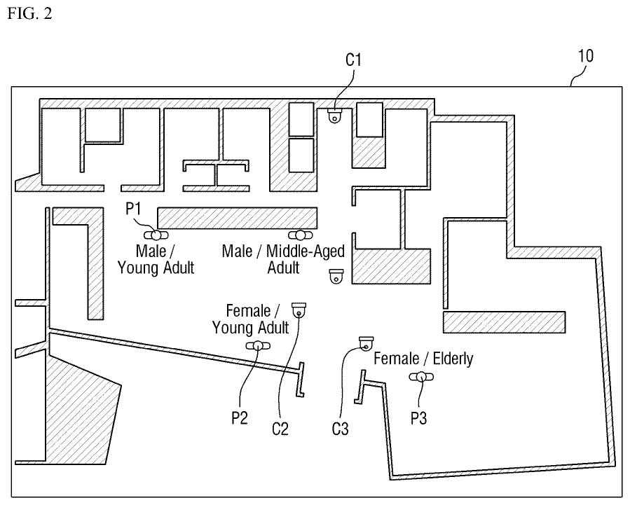

FIG. 2 is a view illustrating an example of an image map of the object information integrated monitoring system illustrated in FIG. 1. In the following description, the same reference numerals as those previously mentioned denote the same components or steps.

Referring to FIG. 2, the object information integrated monitoring system may include a plurality of cameras C₁-C₃ installed in one or more spaces, and may display analytical information on an image map 10 while tracking a movement path of one or more objects P1-P3 recognized in images captured by the plurality of cameras.

In FIG. 2, the positions of the cameras are displayed, and simplified analytical information of each object exposed (or detected) in the images captured by the cameras is displayed.

For example, the analytical information may simply indicate the gender and age group of each object. The gender may be displayed as male or female. The age group may be classified as infant (0 to 12 years old), adolescent (12 to 19 years old), young adult (19 to 34 years old, based on Article 3 of the Framework Act on Young Adults), middle-aged adult (35 to 49 years old), older adult (50 to 64 years old), and elderly (65 years and older), and these classification standards may be adjusted as needed.

In addition, although not illustrated in the drawings, in the step of analyzing images including recognized objects, information such as a color or type of clothing of an object, whether the object is wearing a hat or glasses, whether the object is wearing a mask, whether the object has a mustache, beard, or sideburns, hair length and whether a hairpin or headband is worn, estimated stride size, whether a bag or backpack is carried, and whether the object is carrying a weapon (e.g., knife, gun, etc.) may also be analyzed and provided. Among such analytical information, the object information integrated monitoring system may selectively set only pieces of information required by the supervisor as one information group and display only the information group on the image map.

Also, when the object P1 exposed to a first camera C1 moves and is then exposed to a second camera C2, analytical information may be shared between the first and second cameras C1, C2 and the object P1 may be identified as the same object on the image map 10. For example, when an object exposed in a first image is also exposed in a second image, the object may be recognized as the same object, and its movement path may be continuously tracked on the image map 10 while displaying analytical information.

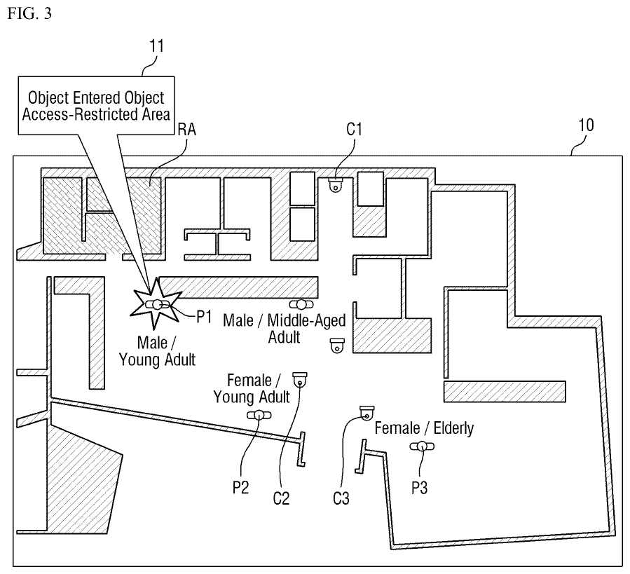

FIG. 3 is a view illustrating an example in which an alert notification is transmitted on the image map of the object information integrated monitoring system illustrated in FIG. 1, and FIG. 4 is a view illustrating an example in which a camera image related to the transmitted alert notification is simultaneously transmitted on the image map illustrated in FIG. 3.

Referring to FIGS. 3 and 4, on the image map 10, a region set as a restricted area in an actual space may be set as a restricted area RA, which may correspond to the step of analyzing images including one or more objects (S130), in FIG. 1, that includes the step of setting a restricted area (S131).

The alert notification 11 in FIG. 3 may be transmitted when, for example but not limited to, the object P1 attempts to enter without undergoing access authentication, or when the object P1 of a specific gender enters a restroom designated for an opposite gender, or when the object P1 attempts to enter an area set as a no-entry zone (e.g., server room, mechanical room, security room, etc.).

FIG. 4 illustrates a state in which in response to the alert notification 11 being transmitted and displayed on the image map as illustrated in FIG. 3, more detailed analytical information and a real-time image 20 are transmitted and displayed on the image map 10.

For example, the alert notification 11 in FIG. 4 indicates that a male attempts to enter or comes out of a women's restroom.

That is, under normal circumstances, a male is not allowed to enter a women's restroom. There may obviously be exceptional situations such as cleaning or maintenance, but such cases are excluded from this description. When a male loiters near or enters the entrance of a women's restroom for a preset time or longer, it may be determined using images captured by a camera that the object is male and may analyze the object as having trespassed into the restricted area RA.

For example, if the object information integrated monitoring system according to an embodiment is applied to public restrooms in schools, offices, airports, or department stores, the supervisor may immediately detect an occurrence of such unauthorized entry into the restricted area RA, thereby taking a prompt response action.

Although not illustrated in the drawings, in similar situations, an alert notification may also be displayed on the image map 10 in the step of reflecting analytical information when, for example but not limited to, an object attempts to enter a security area or mechanical room without using a registered fingerprint or key, when an unauthorized object follows an authorized object into a restricted area, when an unauthorized object enters an authorized-person-only area where only specific objects are permitted, or when an object enters an area temporarily closed due to cleaning or construction.

In the process of displaying the alert notification 11, the real-time camera image 20 of an area where the object that has caused the alert notification 11 is located may be simultaneously displayed on the image map 10. When the analytical information of the object and the alert notification 11 are displayed on the image map 10, and the real-time camera image 20 is simultaneously displayed on the image map 10, the supervisor may make a clearer determination and respond more promptly. Although not illustrated in the drawings, when the real-time camera image 20 is displayed simultaneously with the alert notification 11 on the image map 10, the real-time camera image 20 may be separately stored on a server and used as evidence.

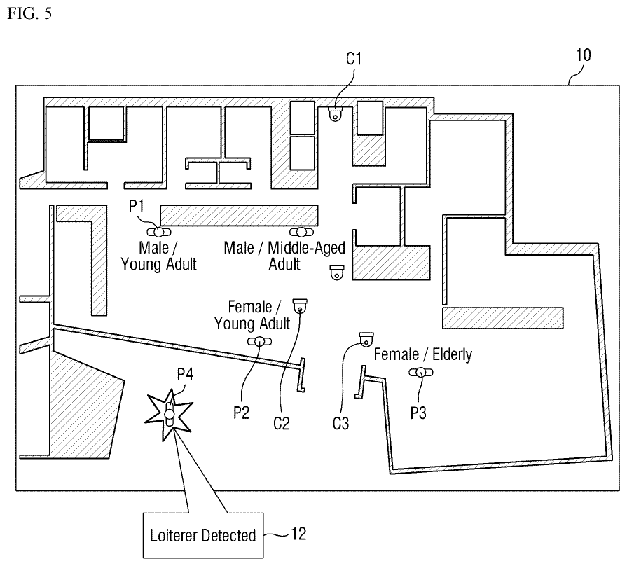

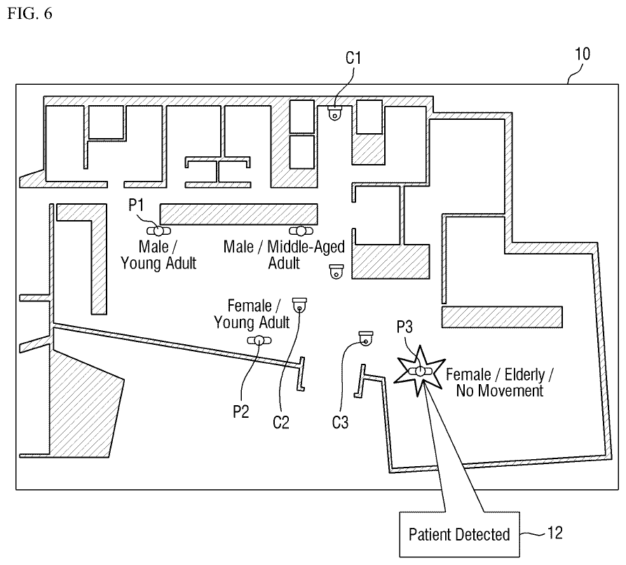

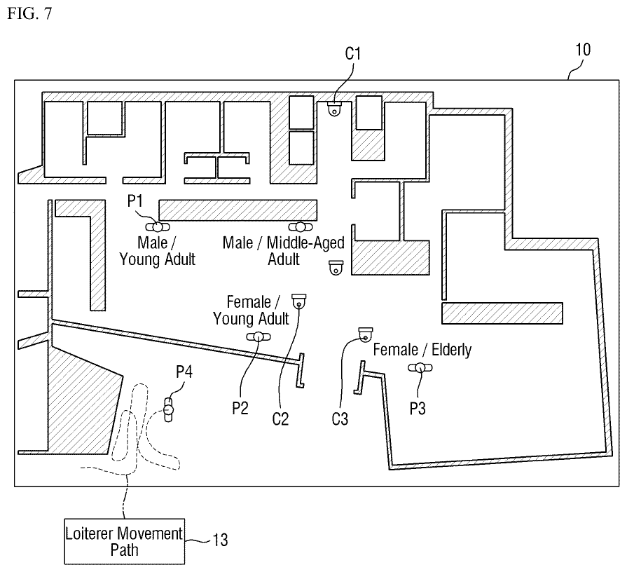

FIGS. 5 and 6 are views illustrating examples in which an event notification is transmitted on the image map of the object information integrated monitoring system illustrated in FIG. 3, and FIG. 7 is a view illustrating an example in which the movement path of an object is displayed on the image map illustrated in FIG. 5.

Referring to FIGS. 5 through 7, the step of reflecting analytical information, described in FIG. 1, may include the step of transmitting an event notification 12.

Here, the step of transmitting the event notification 12 may transmit the event notification 12 to the supervisor when at least one condition is satisfied. Whether the at least one condition is satisfied may be determined by the cameras or a control unit (not illustrated) that controls the cameras based on the stored analytical information.

As described earlier with reference to FIG. 1, the at least one condition for the event notification may include, for example but not limited to: a first condition in which a specific object is repeatedly and/or periodically exposed on the image map; a second condition in which a specific object is exposed on the image map or stays in a restricted area for a preset time or longer; a third condition in which the density of objects in a unit area on the image map exceeds a preset range; a fourth condition in which one or more objects move at a speed exceeding a preset movement speed range; a fifth condition in which a specific object deviates from a cluster formed by multiple objects; and a sixth condition in which at least one person object possesses a weapon such as a knife or firearm.

More detailed descriptions of these conditions are as follows.

In an embodiment, when an object P4 repeatedly loiters and/or is periodically exposed within a specific area on the image map 10, the object P4 may be determined to be a loiterer under the first condition. For example, the object P4 that satisfies the first condition may be determined to be a stalker, undercover police officer, etc., other than a loiterer.

In an embodiment, when a specific object remains exposed on the image map 10 for a preset time or longer, it may be determined to be a homeless person under the second condition. For example, to be determined as homeless under the second condition, an appearance and/or a disappearance at specific times may be repeated for at least two days. Alternatively, as illustrated in FIG. 6, under the second condition, the cameras may detect and analyze a moving object suddenly stopping or slowing down its movement, and transmit the event notification 12 to the supervisor as a possible medical emergency.

In an embodiment, when the third condition is met where the density of objects on the image map 10 exceeds a preset range, the camera(s) and/or the supervisor may determine the corresponding situation to be a gathering of a large number of people such as, for example, a performance, a protest, or a festival, and the supervisor may guide the movement or dispersion of the objects or control entry into a specific area to prevent a safety accident.

In an embodiment, when the fourth condition is met where a plurality of objects move at a speed exceeding a preset movement speed range, the camera(s) and/or the supervisor may determine that an accident such as a fire or earthquake has occurred. Alternatively, if the fourth condition is met at an opening time of a shopping mall or a department store, the supervisor may determine the corresponding situation as an open run or a store opening rush.

In an embodiment, when the fifth condition is met where a specific object deviates from a cluster formed by multiple objects, the supervisor may determine the corresponding situation as a missing child case. That is, when multiple objects move simultaneously within a preset time range or area range in the same or similar direction and at the same or similar speed, the movement may be determined as one clustering trend, and if one specific object deviating from the cluster is detected by the cameras, an event notification may be transmitted to the supervisor, and the supervisor may take an appropriate follow-up action.

In an embodiment, when the sixth condition is met where at least one person object possesses a weapon such as a knife or firearm, the supervisor may promptly request dispatch of a security team or police cooperation, thereby minimizing an accident that may occur due to the armed object.

When one or more conditions among the first through sixth conditions are satisfied, the alert notification 11 and/or the event notification 12 may be displayed on the image map 10, and the real-time camera image 20 (see FIG. 4) may be displayed (e.g., simultaneously displayed). Therefore, the supervisor may respond more promptly to a safety accident through the real-time camera image 20 along with the alert notification 11 and/or the event notification 12.

As illustrated in FIG. 7, the supervisor may selectively check the movement path of a specific object P4 among multiple objects. For example, when the cameras determine the specific object P4 to be a loiterer, and transmit an event notification 13 corresponding to the movement path of the loiterer to the supervisor's image map, the supervisor may immediately confirm it and analyze conditions such as the loiterer's entry time, entry route, duration of stay, and gaze direction during the movement path. If these conditions deviate from a preset range, the object information integrated monitoring system or the supervisor may restrict entry, or transfer the case to the police.

Although not illustrated in the drawings, for example, in the case of a missing child under the fifth condition, the child may be easily found by checking the movement path of the object that has deviated from the cluster. In addition, for example, the object information integrated monitoring system may combine the above-described conditions to provide analytical information or notifications corresponding to such diverse conditions. Alternatively, for example, when the object information integrated monitoring system is installed at a subway station or bus stop, and a middle-aged or elderly person attempts to board a vehicle while carrying luggage, or a person with a disability attempts to board or disembark, the object information integrated monitoring system may provide an event notification to enable the supervisor to recognize the difficulty in boarding or alighting, thereby improving vehicle accessibility for infants, the elderly, pregnant women, and persons with disabilities.

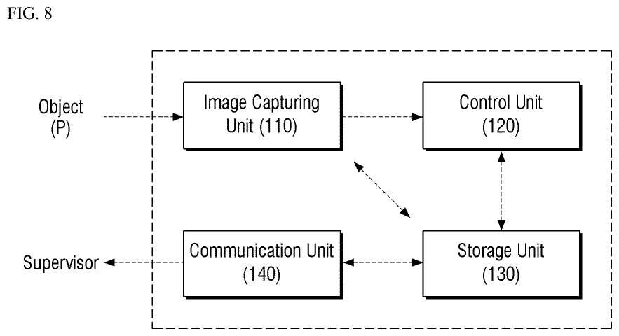

FIG. 8 is a block diagram illustrating the configuration of an object information integrated monitoring system 100 according to an embodiment of the present disclosure.

The object information integrated monitoring system 100 may include an image capturing unit 110, a control unit 120, a storage unit 130, and a communication unit 140.

First, the image capturing unit 110 may include a plurality of cameras. These cameras may be installed on sides or ceiling of a structure. The cameras of the image capturing unit 110 may be arranged at separated positions within each space. The cameras of the image capturing unit 110 may be equipped with an AI algorithm to immediately identify basic information of an object. Images or videos captured by the image capturing unit 110 may be stored directly in the storage unit 130 without undergoing an analysis process. Accordingly, the image capturing unit 110 may recognize and track the object. Furthermore, in the image capturing unit 110, the cameras may recognize the object, and a bounding box may be set for the recognized object.

The control unit 120 may analyze at least one object by receiving image or video information captured by the image capturing unit 110. When the image capturing unit 110 lacks an analysis function or such function is not working, or when the images or videos captured by the image capturing unit 110 are stored in the storage unit 130 without being analyzed, the control unit 120 may derive analytical information by analyzing the stored images or videos. The control unit 120 may also reflect the analytical information on an image map, and simultaneously display the analytical information of the at least one object on the image map while tracking the movement paths of the at least one object. Furthermore, when the image capturing unit 110 does not have a function to recognize or track an object, or such function is not working, the control unit 120 may analyze the at least one object and perform recognition and tracking of the at least one object. In the process of displaying analytical information, the control unit 120 may determine that an object recognized in a first image by a first camera and exposed in a second image by a second camera is the same object, and may continuously track the object on the image map.

The control unit 120 may derive analytical information such as, for example but not limited to, height, age, gender, clothing, presence or absence of disability, location coordinates, movement path, movement speed, density by unit area, exposure time in the first or second image, and clustering trend, when a recognized object is a person. Furthermore, when the recognized object is a vehicle, the control unit 120 may derive analytical information such as, for example but not limited to, vehicle number, color, type, size, location coordinates, movement path, movement speed, entry or exit time, whether a predefined person object is boarding, and the number of boarding or alighting person objects.

The control unit 120 may set a restricted area such as a security area, a mechanical room, a server room, a security room, an authorized-person-only area, a restroom, a nursing room, or a no-entry zone during image analysis. Based on such analytical information, the control unit 120 may transmit an alert notification or an event notification.

The analytical information derived by the control unit 120 through analysis may be stored in the storage unit 130 and/or may be stored in a storage unit prepared in a separate server.

The control unit 120 may function as a controller that controls the operations of other components of the object information integrated monitoring system 100 and may generally be implemented as a central processing unit (CPU), a microprocessor, or the like.

The storage unit 130 may store results analyzed by the control unit 120 and/or stores data necessary for analysis by the control unit 120, and may be implemented as volatile or non-volatile memory, or may be provided on an external server.

The communication unit 140 may include an interface for sending and receiving a transmission packet by being communicatively connected to an external device. The communication unit 140 may be implemented as a wired network interface for connection to a wired line and/or a wireless network interface for connection to a wireless line.

The communication unit 140 may be communicatively connected between the image capturing unit 110 and the control unit 120, between the control unit 120 and the storage unit 130, and/or between the control unit 120 and a supervisor.

An image map viewable by the supervisor may be accessed through a PC, tablet, or mobile terminal such as a mobile phone, and a real-time video transmitted in response to an alert notification or event notification may also be checked through such devices.

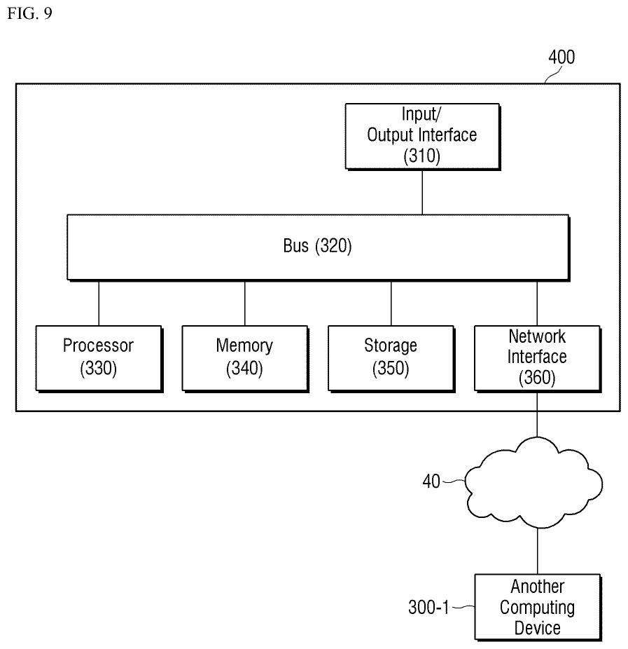

FIG. 9 is a diagram illustrating an example of a hardware configuration of a computing device 300 for implementing the object information integrated monitoring system illustrated in FIG. 8.

The computing device 300 may include a bus 320, a processor 330, a memory 340, a storage 350, an input/output interface 310, and a network interface 360. The bus 320 may be a data transmission path that allows the processor 330, the memory 340, the storage 350, the input/output interface 310, and the network interface 360 to transmit data to and receive data from one another. However, the method of connecting the processor 330 and the like is not limited to bus connections.

The processor 330 may include a computation processing device such as a central processing unit (CPU) or graphics processing unit (GPU). The memory 340 may include a random-access memory (RAM) or a read-only memory (ROM). The storage 350 may include a hard disk, a solid-state drive (SSD), or a memory card. The storage 350 may be a memory such as RAM or ROM.

The input/output interface 310 may be an interface for connecting the computing device 300 to input/output devices. For example, a keyboard or a mouse may be connected to the input/output interface 310.

The network interface 360 may be an interface for enabling the computing device 300 to be communicatively connected to an external device and to send and receive transmission packets. The network interface 360 may be a network interface for connection to a wired line or a network interface for connection to a wireless line. For example, the computing device 300 may be connected to another computing device 300-1 through a network 200.

The storage 350 may store program modules that implement the functions of the computing device 300. The processor 330 may execute each of the program modules, thereby implementing the corresponding function. When executing each module, the processor 330 may load the corresponding module into the memory 340.

However, the hardware configuration of the computing device 300 is not limited to that illustrated in FIG. 9. For example, each program module may also be stored in the memory 340. In this case, the computing device 300 may not be required to include the storage 350.

As such, the object information integrated monitoring system 100 may include at least the processor 330 and the memory 340 that stores instructions executable by the processor 330. In particular, the object information integrated monitoring system 100 may operate by having the processor 330 execute instructions that include various function blocks or steps.

Therefore, according to the control method for the object information integrated monitoring system of the present disclosure, a single monitor may recognize at least one object through cameras while analytical information is being displayed, and may simultaneously track a movement path of the at least one object, thereby enabling monitoring of the at least one object. Since analytical information of the at least one object is displayed on an image map, it becomes easier to track each object or identify the characteristics of each object. Furthermore, alert notifications or event notifications may be transmitted to prevent a safety accident involving the at least one object or promptly handle an accident that have occurred, and by transmitting a real-time camera image in the process of sending the notifications and reflecting analytical information, the supervisor may more accurately understand the object and the situation in the image including the object.

According to the control method for the object information integrated monitoring system of the present disclosure, the following advantages may be provided.

First, a single supervisor may recognize one or more objects through cameras while the object information integrated monitoring system displays analytical information of the one or more objects and simultaneously track a movement path of the one or more objects, thereby allowing the supervisor to grasp the at least one object and a situation surrounding the at least one object.

Second, since the analytical information of the at least one object is displayed on an image map, tracking each object of the at least one object or identifying characteristics of each object of the at least one object is facilitated.

Third, an alert notification and/or an event notification may be transmitted to prevent a safety incident involving the at least one object or to quickly handle an accident that has occurred.

Fourth, a real-time camera image may be transmitted along with an alert notification and/or an event notification to be displayed on the image map, the supervisor may more accurately identify the at least one object and the situation in the images that include the at least one object.

The effects of the present disclosure are not limited to those mentioned above, and other effects not mentioned will be clearly understood by those skilled in the art from the claims.

At least one of the components, elements, modules or units (collectively “components” in this paragraph) represented by a block in the drawings, may be embodied as various numbers of hardware, software and/or firmware structures that execute respective functions described above, according to one or more example embodiments. For example, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, although a bus is not illustrated in the above block diagrams, communication between the components may be performed through the bus. Functional aspects of the above example embodiments may be implemented in algorithms that execute on one or more processors. Furthermore, the components represented by a block or processing steps may employ any number of related art techniques for electronics configuration, signal processing and/or control, data processing and the like.

While the technical idea of the disclosure has been illustrated and described in detail with reference to example embodiments, the present disclosure is not limited to the specific configurations and operations of these embodiments. Various modifications can be made within the scope of the disclosure without departing from its spirit. Therefore, such modifications should be considered within the scope of the disclosure, and the scope of the disclosure should be determined by the appended claims.

What is claimed is:

1. A control method of an object information integrated monitoring system, comprising:
recognizing at least one first object in a first image captured by a first camera, setting a bounding box with respect to the at least one first object, and tracking the at least one first object;
obtaining analytical information by analyzing the first image comprising the at least one first object; and
displaying, based on the analytical information, an image map corresponding to the captured first image,
wherein the displaying comprises displaying, on the image map, analytical information of the at least one first object while tracking a movement path of the at least one first object on the image map.

2. The control method of claim 1, further comprising:
recognizing at least one second object appearing in a second image captured by a second camera;
setting a bounding box with respect to the at least one second object; and
tracking the at least one second object.

3. The control method of claim 2, wherein the displaying comprises:
recognizing that an object, among the at least one first object, recognized in the first image and an object, is a same object as an object, among the at least one second object, recognized in the second image;
tracking a movement path of the same object on the image map; and
displaying analytical information of the same object.

4. The control method of claim 1, wherein the at least one first object comprises a person and the analytical information of the at least one first object comprises at least one or more pieces of information among height, age, gender, clothing, presence or absence of disability, location coordinates, movement path, movement speed, possession of a weapon, density by unit area, exposure time in the first image, and clustering trend.

5. The control method of claim 1, wherein the analyzing the first image comprises setting a restricted area, which is in a designated area of the first image, on the image map.

6. The control method of claim 5, wherein the restricted area comprises an area that requires an access authentication procedure, an authorized-person-only area to which only a specific object is allowed to enter without authentication, an area to which access is restricted based on gender, and a no-entry zone to which access is not allowed.

7. The control method of claim 6, wherein the restricted area comprises at least one of a security area, a mechanical room, a server room, a security room, a restroom, or a nursing room.

8. The control method of claim 6, wherein the displaying the image map comprises displaying the image map comprising a warning notification, based on a determination that an object among the at least one first object who is not allowed to enter the restricted area has entered the restricted area.

9. The control method of claim 8, wherein the determination that an object among the at least one first object who is not allowed to enter the restricted area has entered the restricted area comprises a determination that an object among the at least one first object enters the restricted area without undergoing access authentication, is an object of a gender different from an allowed gender of the restricted area, or enters the no-entry zone.

10. The control method of claim 5, wherein the displaying the image map comprises displaying the image map comprising an event notification based on at least one of conditions being met, and
wherein the conditions comprises:
a first condition that a specific object is repeatedly and/or periodically exposed based on the stored analytical information;
a second condition that a specific object is exposed on the image map and/or stays in the restricted area for a preset time or longer;
a third condition that a density of objects in a unit area exceeds a set range;
a fourth condition that one or more objects move at a speed exceeding a preset speed range;
a fifth condition that a specific object deviates from a cluster formed by multiple objects; and
a sixth condition that at least one object possesses a weapon.

11. The control method of claim 8, wherein the displaying the image map comprises displaying the image map and an image from a camera capturing a specific object corresponding to the warning notification.

12. The control method of claim 10, wherein the displaying the image map comprises displaying the image map and an image from a camera capturing a specific object corresponding to the event notification.

13. The control method of claim 1, wherein the at least one first object comprises a vehicle and the analytical information of the at least one first object comprises at least one or more pieces of information among a vehicle number, color, type, size, location coordinates, movement path, movement speed, entry or exit time, whether a predefined person object is boarding, and a number of person objects boarding or alighting.

14. The control method of claim 8, wherein the obtaining the analytical information comprises setting an exception object among the at least one first object.

15. The control method of claim 14, wherein the setting the exception object comprises:
setting, as the exception object, an object for which a warning notification is required; and
displaying a movement path or analytical information of the exception object on the image map.

16. The control method of claim 10, wherein the obtaining the analytical information comprises setting an exception object among the at least one first object.

17. The control method of claim 16, wherein the setting the exception object comprises:
setting, as the exception object, an object which satisfies the at least one of conditions; and
displaying a movement path or analytical information of the exception object on the image map.

18. An object information integrated monitoring system comprising:
a memory storing instructions; and
at least one processor configured to execute the instructions,
wherein, by executing the instructions, the at least one processor is configured to perform:
recognizing at least one first object in a first image captured by a first camera, setting a bounding box with respect to the at least one first object, and tracking the at least one first object;
obtaining analytical information by analyzing the first image comprising the at least one first object; and
displaying, based on the analytical information, an image map corresponding to the captured first image,
wherein the displaying comprises displaying, on the image map, analytical information of the at least one first object while tracking a movement path of the at least one first object on the image map.

19. The system of claim 18, wherein the at least one processor is further configured to perform:
recognizing at least one second object appearing in a second image captured by a second camera;
setting a bounding box with respect to the at least one second object; and
tracking the at least one second object.

20. The system of claim 19, wherein the at least one processor is further configured to perform, in displaying the image map:
recognizing that an object, among the at least one first object, recognized in the first image and an object, is a same object as an object, among the at least one second object, recognized in the second image;
tracking a movement path of the same object on the image map; and
displaying analytical information of the same object.
